(19) United States
(12) Patent Application Publication
(10) Pub. No.: US 2024/0412900 A1
(43) Pub. Date: Dec. 12, 2024

(54) RESISTOR

(71) Applicant: ROHM CO., LTD., Kyoto (JP)

(72) Inventor: Kosaku TANAKA, Kyoto (JP)

(21) Appl. No.: 18/671,372

(22) Filed: May 22, 2024

(30) Foreign Application Priority Data
Jun. 9, 2023 (JP) 2023-095433

(51) Int. Cl. H01C 1/14; H01C 7/18

(52) U.S. Cl. CPC H01C 1/14; H01C 7/18

(57) ABSTRACT

A resistor includes: a frame including a resistive body and a resin layer; a protective film; and a first electrode and a second electrode, wherein the resistive body includes a surface and is buried in the resin layer such that the surface is exposed, wherein the protective film is disposed over a central portion of the surface in a first direction, wherein the first electrode is disposed over one end portion of the surface in the first direction and extends to reach over the protective film, wherein the second electrode is disposed over the other end portion of the surface in the first direction and extends to reach over the protective film, and wherein a width of the resistor in a second direction perpendicular to the first direction is wider than a width of the resistor in the first direction.

### CROSS-REFERENCE TO RELATED APPLICATION

This application is based upon and claims the benefit of priority from Japanese Patent Application No. 2023-095433, filed on Jun. 9, 2023, the entire contents of which are incorporated herein by reference.

### TECHNICAL FIELD

The present disclosure relates to a resistor.

### BACKGROUND

A resistor is disclosed in the related art. The resistor described in the related art includes an insulating plate, a resistive body, a protective film, a first electrode, and a second electrode. The resistive body includes a surface. The resistive body is buried in the insulating plate while the surface thereof is exposed.

The protective film is disposed over a central portion of the surface of the resistive body in a first direction. The first electrode and the second electrode are respectively disposed over one end portion and the other end portion of the surface of the resistive body in the first direction. Each of the first electrode and the second electrode extends to reach over the protective film. In the resistor described in Patent Document 1, a width in a second direction is narrower than a width in the first direction. The second direction is a direction perpendicular to the first direction.

### BRIEF DESCRIPTION OF DRAWINGS

The accompanying drawings, which are incorporated in and constitute a part of the specification, illustrate embodiments of the present disclosure.

FIG. 1 is a bottom view of a resistor.

FIG. 2 is a cross-sectional view taken along line II-II in FIG. 1.

FIG. 3 is a plan view of the resistor.

FIG. 4 is a process diagram showing a method of manufacturing the resistor.

FIG. 5 is a bottom view for explaining a preparation step S1.

FIG. 6 is a bottom view for explaining a first base layer forming step S2.

FIG. 7 is a bottom view for explaining a protective film forming step S3.

FIG. 8 is a bottom view for explaining a second base layer forming step S4.

FIG. 9 is a cross-sectional view for explaining a first cutting step S5.

FIG. 10 is a bottom view for explaining a second cutting step S6.

FIG. 11 is a cross-sectional view for explaining a plating step S7.

FIG. 12 is a bottom view of a resistor.

FIG. 13 is a bottom view of a resistor.

FIG. 14 is a cross-sectional view taken along line XIV-XIV in FIG. 13.

FIG. 15 is a bottom view of a resistor according to a modification.

FIG. 16 is a bottom view for explaining a second base layer forming step S4 in a method of manufacturing the resistor.

FIG. 17 is a bottom view for explaining a plating step S7 in the method of manufacturing the resistor.

FIG. 18 is a bottom view of a resistor.

FIG. 19 is a cross-sectional view taken along line XIX-XIX in FIG. 18.

FIG. 20 is a plan view of the resistor.

FIG. 21 is a bottom view of a resistor according to a first modification.

FIG. 22 is a cross-sectional view of a resistor according to a second modification.

FIG. 23 is a process diagram showing a method of manufacturing the resistor.

FIG. 24 is a bottom view for explaining a preparation step S8.

FIG. 25 is a bottom view for explaining a protective film forming step S9.

FIG. 26 is a bottom view for explaining a first plating step S10.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Details of embodiments of the present disclosure will be described with reference to the drawings. Throughout the following drawings, the same or corresponding parts are denoted by the same reference numerals, and duplicate explanation thereof will not be repeated.

### First Embodiment

A resistor according to a first embodiment will be described. The resistor according to the first embodiment is referred to as a resistor 100.

### Configuration of Resistor 100

A configuration of the resistor 100 will be described below.

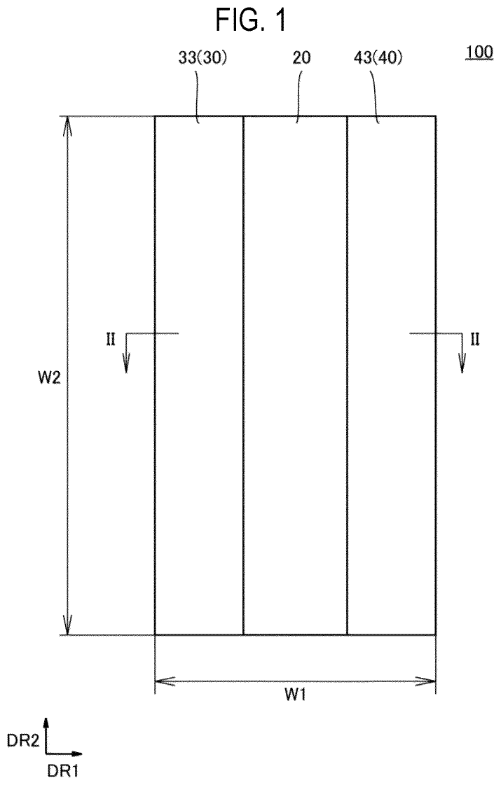

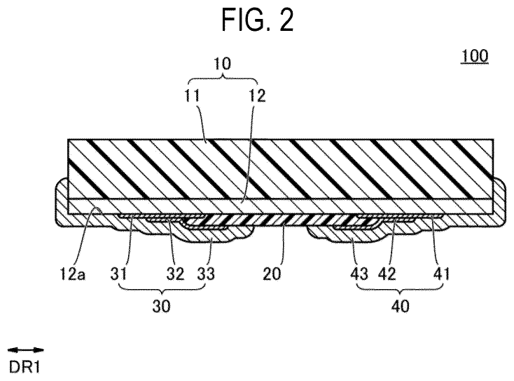

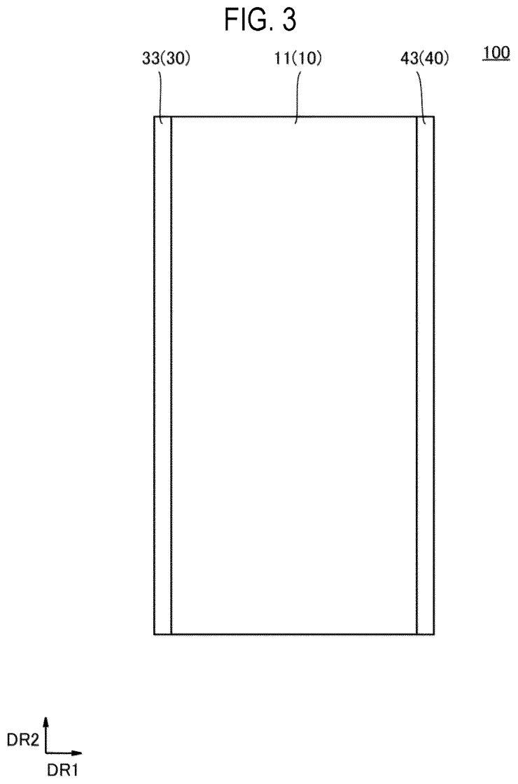

FIG. 1 is a bottom view of the resistor 100. FIG. 2 is a cross-sectional view taken along line II-II in FIG. 1. FIG. 3 is a plan view of the resistor 100. As shown in FIGS. 1 to 3, the resistor 100 includes a frame 10, a protective film 20, an electrode 30, and an electrode 40.

The frame 10 includes a resin layer 11 and a resistive body 12. A constituent material of the resin layer 11 is a resin material. The constituent material of the resin layer 11 is, for example, glass epoxy. A constituent material of the resistive body 12 is a metal material. The constituent material of the resistive body 12 is, for example, a manganese-copper alloy, a copper-nickel alloy, a nickel-chromium alloy, or the like. The resistive body 12 includes a surface 12a. The resistive body 12 is buried in the resin layer 11 such that the surface 12a is exposed. The frame 10 has a rectangular shape in a plan view. Short sides and long sides of this rectangle are along a first direction DR1 and a second direction DR2, respectively. The second direction DR2 is a direction perpendicular to the first direction DR1.

Although not shown, a first slit and a second slit may be formed at the resistive body 12 in order to adjust a resistance of the resistive body 12. The first slit and the second slit penetrate the resistive body 12 in a thickness direction. The first slit is formed at one end of the resistive body 12 in the second direction DR2 and extends along the second direction DR2. The second slit is formed at the other end of the resistive body 12 in the second direction DR2 and extends along the second direction DR2.

A constituent material of the protective film 20 is an electrically insulating material. The constituent material of the protective film 20 is, for example, epoxy resin. The protective film 20 may contain a filler. A constituent material of the filler is, for example, a ceramic material such as alumina or boron nitride. The protective film 20 is disposed over a central portion of the surface 12a in the first direction DR1. The protective film 20 is not arranged on both end portions of the surface 12a in the first direction DR1.

The electrode 30 includes a base layer 31, a base layer 32, and a plating layer 33. A constituent material of the base layer 31 is, for example, a conductive resin material. The conductive resin material includes a resin material and metal particles. The resin material is, for example, epoxy resin. A constituent material of the metal particles is, for example, silver. The base layer 31 is disposed over one end portion of the surface 12a in first direction DR1. One end portion of the base layer 31 in the first direction DR1 is spaced apart from one end of the surface 12a in the first direction DR1. One end portion of the protective film 20 in the first direction DR1 is on the other end portion of the base layer 31 in the first direction DR1.

A constituent material of the base layer 32 is, for example, a conductive resin material. The conductive resin material includes a resin material and metal particles. The resin material is, for example, epoxy resin. A constituent material of the metal particles is, for example, silver. The base layer 32 is disposed over the base layer 31. The base layer 32 extends to reach over the protective film 20. That is, the other end portion of the base layer 32 in the first direction DR1 is on the protective film 20.

The plating layer 33 is a layer formed by plating. The plating layer 33 includes, for example, a copper layer, a nickel layer disposed over the copper layer, and a tin layer disposed over the nickel layer. The plating layer 33 is disposed over the base layer 31 or the base layer 32. However, a portion of the plating layer 33 is disposed over the surface 12a. The other end portion of the plating layer 33 in the first direction DR1 may be disposed over the protective film 20. The plating layer 33 may also be disposed over a side surface of the frame 10 at one end in the first direction DR1.

The electrode 40 includes a base layer 41, a base layer 42, and a plating layer 43. A constituent material of the base layer 41 is, for example, a conductive resin material. The conductive resin material includes a resin material and metal particles. The resin material is, for example, epoxy resin. A constituent material of the metal particles is, for example, silver. The base layer 41 is disposed over the other end portion of the surface 12a in first direction DR1. The other end portion of the base layer 41 in the first direction DR1 is spaced apart from the other end of the surface 12a in the first direction DR1. The other end portion of the protective film 20 in the first direction DR1 is on one end portion of the base layer 41 in the first direction DR1.

A constituent material of the base layer 42 is, for example, a conductive resin material. The conductive resin material includes a resin material and metal particles. The resin material is, for example, epoxy resin. A constituent material of the metal particles is, for example, silver. The base layer 42 is disposed over the base layer 41. The base layer 42 extends to reach over the protective film 20. That is, one end portion of the base layer 42 in the first direction DR1 is on the protective film 20.

The plating layer 43 is a layer formed by plating. The plating layer 43 includes, for example, a copper layer, a nickel layer disposed over the copper layer, and a tin layer disposed over the nickel layer. The plating layer 43 is disposed over the base layer 41 or the base layer 42. However, a portion of the plating layer 43 is disposed over the surface 12a. One end portion of the plating layer 43 in the first direction DR1 may be disposed over the protective film 20. The plating layer 43 may also be disposed over a side surface of the frame 10 at the other end in the first direction DR1.

A width of the resistor 100 in the first direction DR1 is defined as a width W1. A width of the resistor 100 in the second direction DR2 is defined as a width W2. The width W2 is wider than the width W1. That is, a longitudinal direction of the resistor 100 is along the second direction DR2. The width W2 is preferably 3.2 mm or less.

### Method of Manufacturing Resistor 100

A method of manufacturing the resistor 100 will be described below.

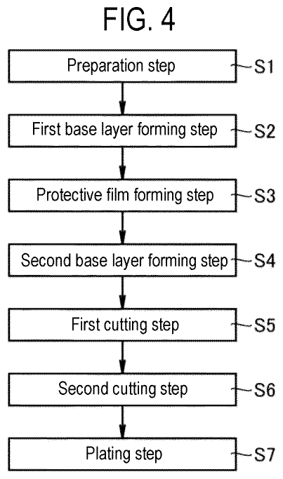

FIG. 4 is a process diagram showing a method of manufacturing the resistor 100. As shown in FIG. 4, the method of manufacturing the resistor 100 includes a preparation step S1, a first base layer forming step S2, a protective film forming step S3, a second base layer forming step S4, a first cutting step S5, a second cutting step S6, and a plating step S7.

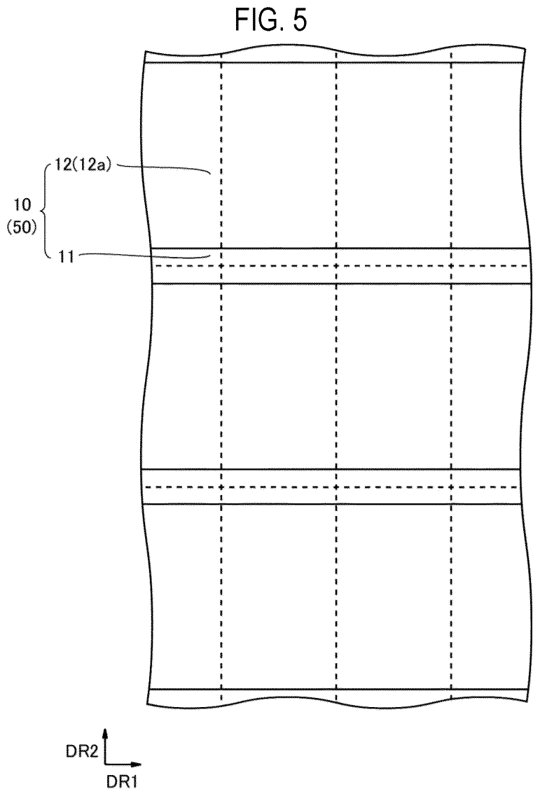

FIG. 5 is a bottom view for explaining the preparation step S1. As shown in FIG. 5, in the preparation step S1, a frame 50 is prepared. The frame 50 includes a plurality of frames 10. In FIG. 5, each of the plurality of frames 10 included in the frame 50 is divided by a dotted line. After the preparation step S1, the first base layer forming step S2 is performed.

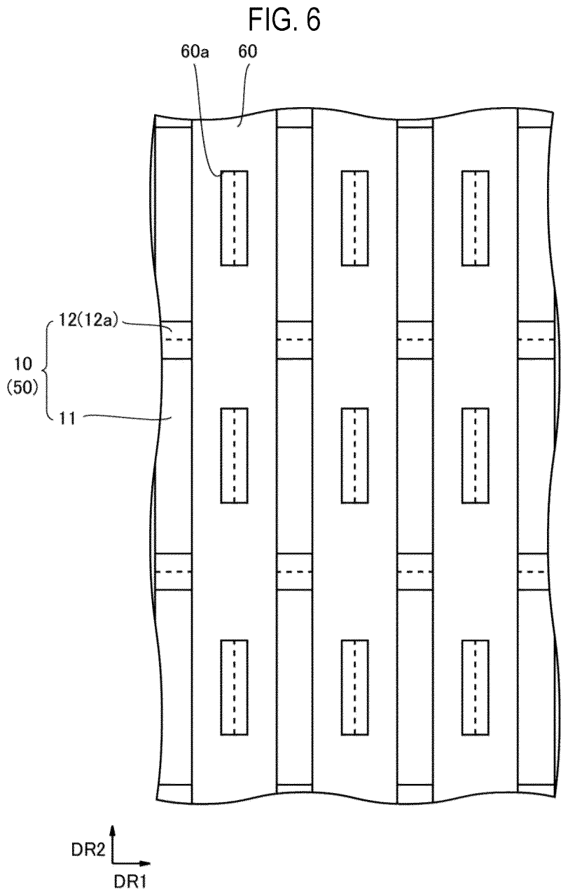

FIG. 6 is a bottom view for explaining the first base layer forming step S2. As shown in FIG. 6, in the first base layer forming step S2, a base layer 60 is formed. In the first base layer forming step S2, first, a paste including an uncured resin material and metal particles is applied. Second, by heating the applied paste, the resin material is cured to form the base layer 60. Note that an opening 60a is formed in each base layer 60. A surface 12a is exposed through the opening 60a. After the first base layer forming step S2, the protective film forming step S3 is performed.

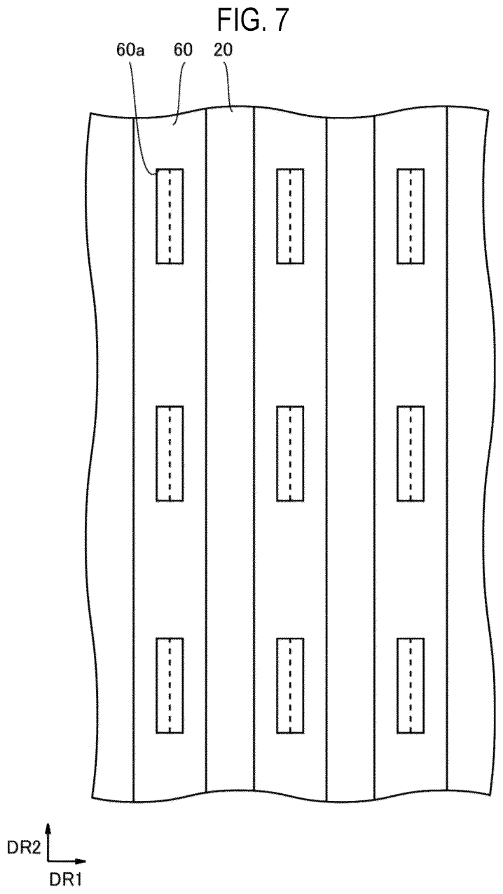

FIG. 7 is a bottom view for explaining the protective film forming step S3. As shown in FIG. 7, in the protective film forming step S3, the protective film 20 is formed. In the protective film forming step S3, first, the constituent material (uncured resin material) of the protective film 20 is applied. Second, the applied uncured resin material is heated and cured to form the protective film 20. After the protective film forming step S3, the second base layer forming step S4 is performed.

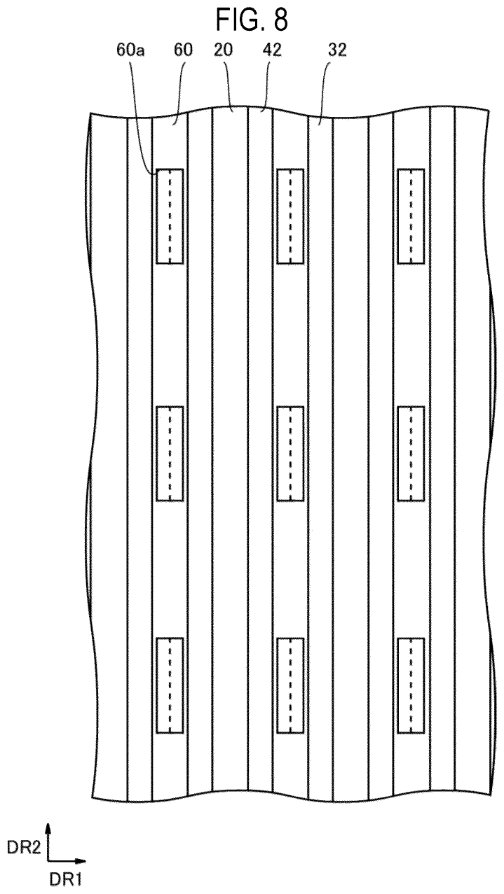

FIG. 8 is a bottom view for explaining the second base layer forming step S4. As shown in FIG. 8, in the second base layer forming step S4, the base layer 32 and the base layer 42 are formed. In the second base layer forming step S4, first, a paste containing an uncured resin material and metal particles is applied. Second, by heating the applied paste, the resin material is cured to form the base layer 32 and the base layer 42. After the second base layer forming step S4, the first cutting step S5 is performed.

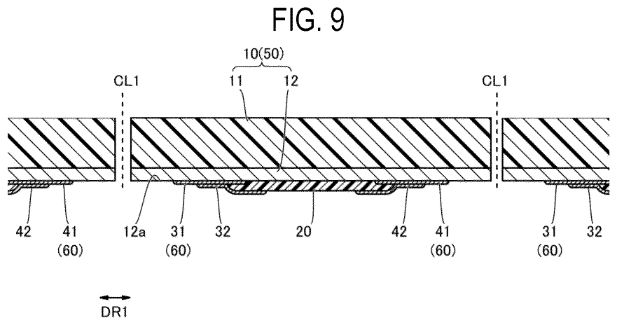

FIG. 9 is a cross-sectional view for explaining the first cutting step S5. As shown in FIG. 9, in the first cutting step S5, the frame 50 is cut along a cutting line CL1. The cutting line CL1 is along the second direction DR2. As the frame 50 is cut, the base layer 60 is also separated to form the base layer 31 and the base layer 41. After the first cutting step S5, the second cutting step S6 is performed.

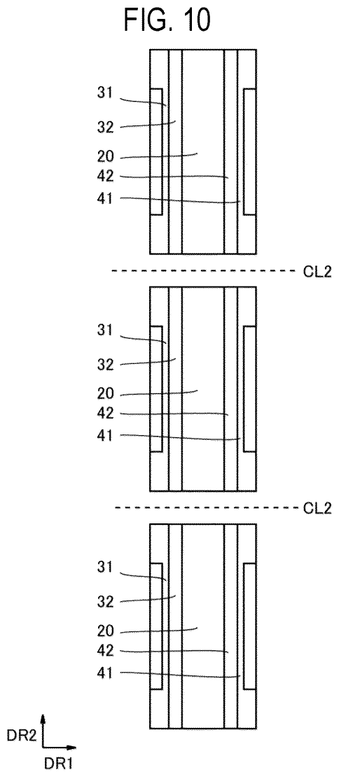

FIG. 10 is a bottom view for explaining the second cutting step S6. As shown in FIG. 10, in the second cutting step S6, the frame 50 is cut along a cutting line CL2. The cutting line CL2 is along the first direction DR1. As a result, the frame 50 is segmented into the plurality of frames 10. After the second cutting step S6, the plating step S7 is performed.

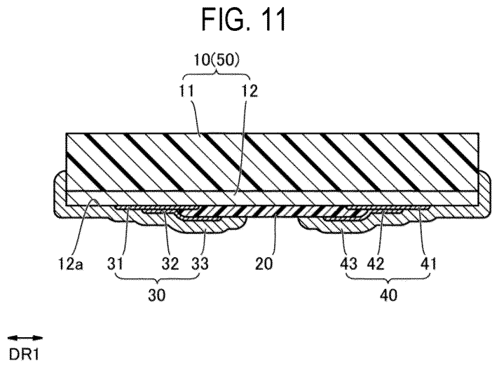

FIG. 11 is a cross-sectional view for explaining the plating step S7. As shown in FIG. 11, in the plating step S7, electrolytic barrel plating is performed to sequentially form a copper layer, a nickel layer, and a tin layer. Through the above steps, a structure of the resistor 100 shown in FIGS. 1 to 3 is formed.

### Effects of Resistor 100

Effects of the resistor 100 will be described below in comparison with a resistor according to a comparative example. The resistor according to the comparative example is referred to as a resistor 100A.

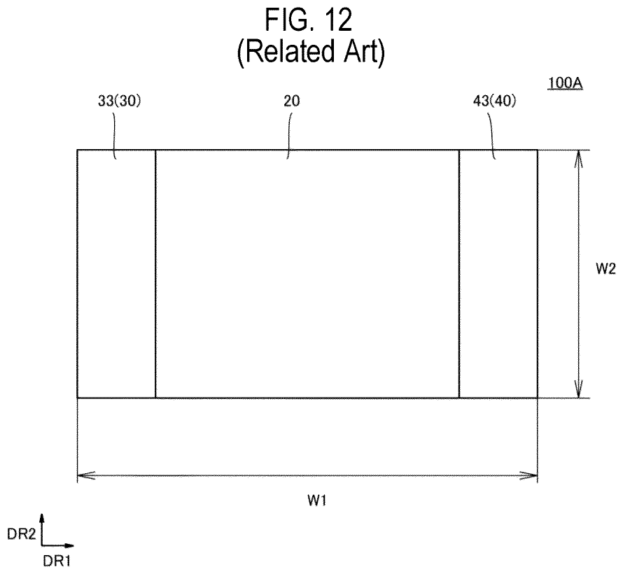

FIG. 12 is a bottom view of the resistor 100A. As shown in FIG. 12, in the resistor 100A, a width W2 is narrower than a width W1. Except for this point, the configuration of resistor 100A is the same as that of the resistor 100.

The resistor 100 and the resistor 100A are soldered to a substrate at the electrodes 30 and 40. In the resistor 100, since the width W2 is wider than the width W1, when comparing the same size, a contact area with the substrate is larger than that of the resistor 100A. Therefore, in the resistor 100, as compared to the resistor 100A, heat generated in the resistive body 12 from the electrodes 30 and 40 is more easily dissipated to the substrate via a solder bonding portion, thereby improving the heat dissipation to the substrate.

In order to reduce the width W2 of the resistor 100 and the resistor 100A, it is necessary to reduce the width of the resistive body 12 in the second direction DR2 in the frame 50. However, when the width of the resistive body 12 in the second direction DR2 is reduced, rigidity of the frame 50 is reduced, reducing handling ability of the frame 50. This becomes noticeable when the width W2 becomes 3.2 mm or less. In this respect, in the resistor 100, since the width W2 is wider than the width W1, it is possible to reduce the width W1 without reducing the width W2 to achieve miniaturization. Therefore, according to the resistor 100, it is possible to improve the handling ability of the frame 50 during manufacturing.

### Second Embodiment

A resistor according to a second embodiment will be described. The resistor according to the second embodiment is referred to as a resistor 200. Herein, points different from the resistor 100 will be mainly described, and duplicate explanation thereof will not be repeated.

### Configuration of Resistor 200

A configuration of the resistor 200 will be described below.

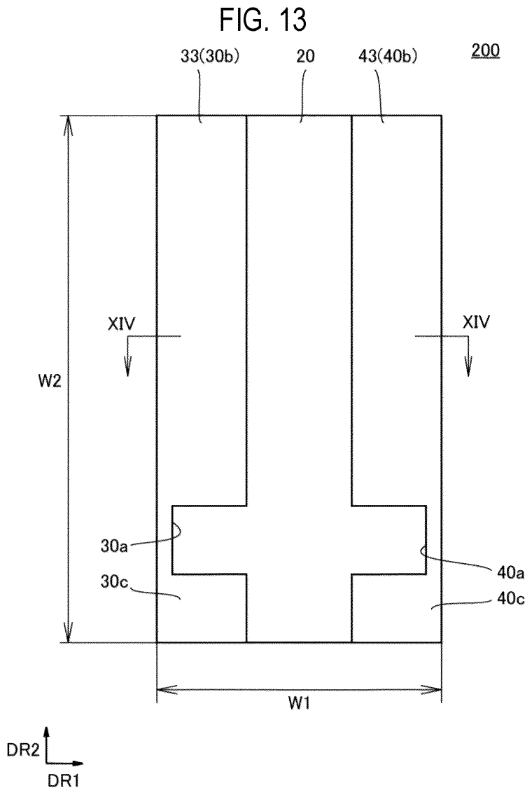

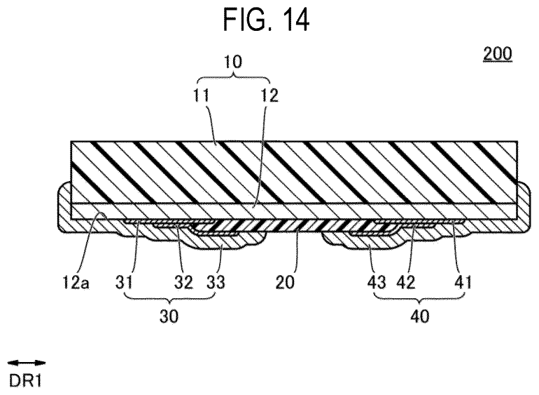

FIG. 13 is a bottom view of the resistor 200. FIG. 14 is a cross-sectional view taken along line XIV-XIV in FIG. 13. As shown in FIGS. 13 and 14, the resistor 200 includes a frame 10, a protective film 20, and electrodes 30 and 40. In this regard, the configuration of the resistor 200 is the same as that of the resistor 100.

In the resistor 200, a recess 30a is formed at an end of the electrode 30 near the electrode 40 (one end of the electrode 30 in the first direction DR1), and a recess 40a is formed at an end of the electrode 40 near the electrode 30 (the other end of the electrode 40 in the first direction DR1). The protective film 20 is exposed from the recesses 30a and 40a. In this regard, the configuration of the resistor 200 is different from that of the resistor 100.

A portion of the electrode 30 adjacent to the recess 30a in the second direction DR2 is referred to as a first portion 30b, and a portion of the electrode 30 adjacent to the recess 30a from an opposite side from the first portion 30b in the second direction DR2 is referred to as a second portion 30c. Further, a portion of the electrode 40 adjacent to the recess 40a in the second direction DR2 is referred to as a first portion 40b, and a portion of the electrode 40 adjacent to the recess 40a from an opposite side from the first portion 40b in the second direction DR2 is referred to as a second portion 40c.

A width of the first portion 30b in the second direction DR2 is wider than, for example, a width of the second portion 30c in the second direction DR2. A width of the first portion 40b in the second direction DR2 is wider than, for example, a width of the second portion 40c in the second direction DR2. In this case, the resistor 200 is used as, for example, a shunt resistor. That is, in this case, the resistor 200 detects a voltage between the second portion 30c and the second portion 40c while a current is flowing between the first portion 30b and the first portion 40b, making it possible to detect a current flowing between the first portion 30b and the first portion 40b.

### Modifications

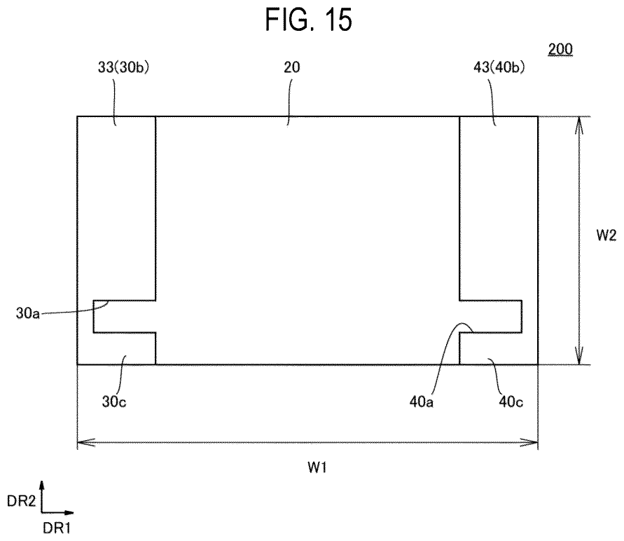

In the above, an example in which a width W2 is wider than a width W1 has been described. FIG. 15 is a bottom view of a resistor 200 according to a modification. As shown in FIG. 15, in the resistor 200, the width W2 may be narrower than the width W1.

### Method of Manufacturing Resistor 200

A method of manufacturing the resistor 200 will be described below.

The method of manufacturing the resistor 200 includes a preparation step S1, a first base layer forming step S2, a protective film forming step S3, a second base layer forming step S4, a first cutting step S5, a second cutting step S6, and a plating step S7. In this regard, the method of manufacturing the resistor 200 is the same as the method of manufacturing the resistor 100.

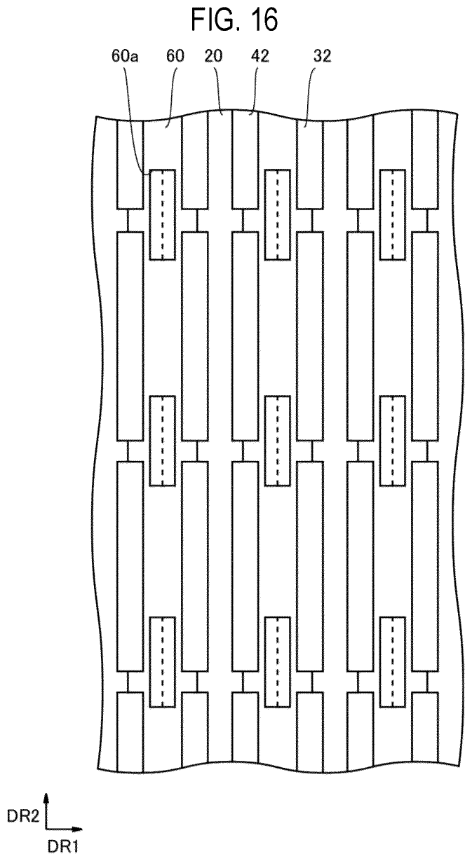

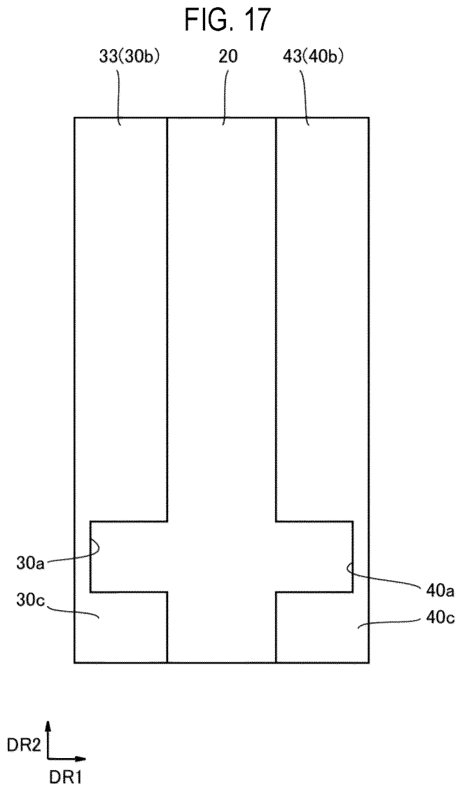

FIG. 16 is a bottom view for explaining the second base layer forming step S4 in the method of manufacturing the resistor 200. As shown in FIG. 16, in the second base layer forming step S4 in the method of manufacturing the resistor 200, a base layer 32 and a base layer 42 are formed at intervals in the second direction DR2. FIG. 17 is a bottom view for explaining the plating step S7 in the method of manufacturing the resistor 200. A plating layer 33 is not able to grow on the protective film 20 exposed between adjacent base layers 32, and a plating layer 44 is not able to grow on the protective film 20 exposed between adjacent base layers 42. Therefore, in the method of manufacturing the resistor 200, by performing the plating step S7, the recess 30a is formed at the electrode 30 and the recess 40a is formed at the electrode 40, as shown in FIG. 17. In this respect, the method of manufacturing the resistor 200 is different from the method of manufacturing the resistor 100.

### Effects of Resistor 200

Effects of the resistor 200 will be described below.

In the resistor 200, by forming the base layer 32 and the base layer 42 at intervals along the second direction DR2 when the second base layer forming step S4 is performed, the recess 30a and the recess 40a are formed at the electrode 30 and the electrode 40, respectively. In this way, the resistor 200 may be made into four terminals without adding any new step and may be used as, for example, a shunt resistor.

### Third Embodiment

A resistor according to a third embodiment will be described. The resistor according to the third embodiment is referred to as a resistor 300. Herein, points different from the resistor 200 will be mainly described, and duplicate explanation thereof will not be repeated.

### Configuration of Resistor 300

A configuration of the resistor 300 will be described below.

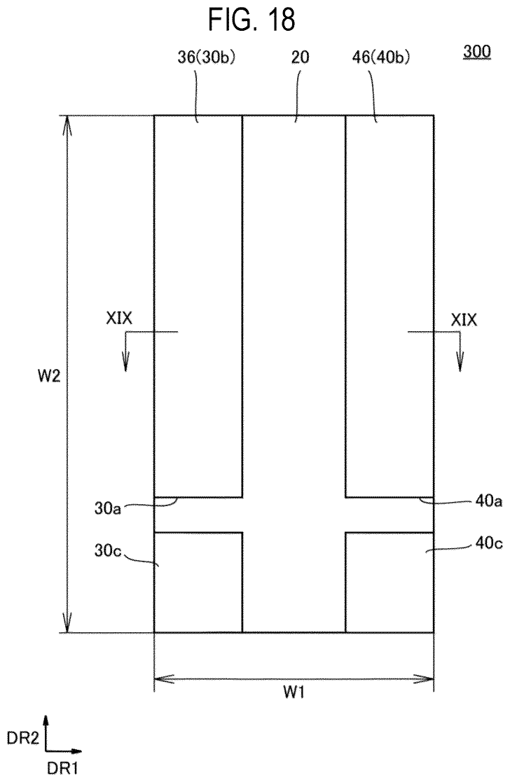

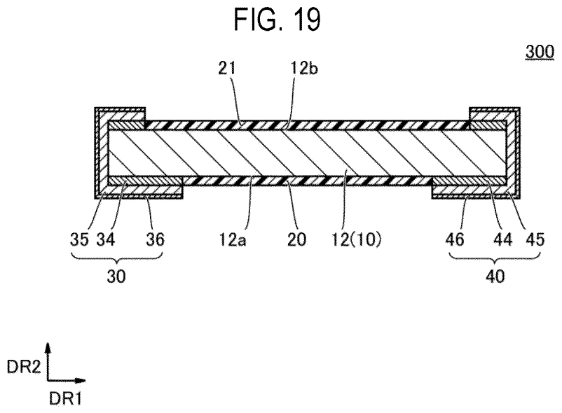

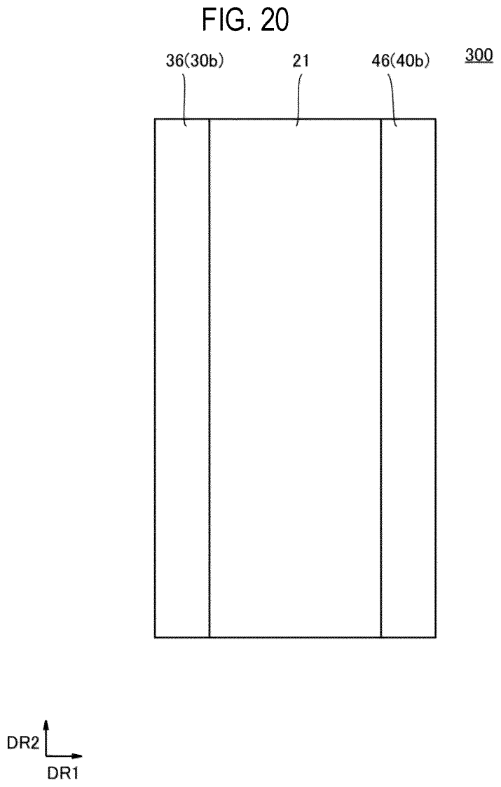

FIG. 18 is a bottom view of the resistor 300. FIG. 19 is a cross-sectional view taken along line XIX-XIX in FIG. 18. FIG. 20 is a plan view of the resistor 300. As shown in FIGS. 18 to 20, the resistor 300 includes a frame 10, a protective film 20, an electrode 30, and an electrode 40. In this regard, the configuration of the resistor 300 is the same as that of the resistor 200.

In the resistor 300, the frame 10 includes a resistive body 12. A surface of the resistive body 12 on an opposite side from the surface 12a is referred to as a surface 12b.

In the resistor 300, the electrode 30 includes a plating layer 34, a plating layer 35, and a plating layer 36. A constituent material of the plating layer 34, a constituent material of the plating layer 35, and a constituent material of the plating layer 36 are, for example, copper, nickel, and tin, respectively. The plating layer 34 is disposed over one end portion of the surface 12a in the first direction DR1. The plating layer 34 is also disposed over one end portion of the surface 12b in the first direction DR1. The plating layer 35 is disposed over the plating layer 34. The plating layer 35 is also disposed over a side surface of the resistive body 12 at one end in the first direction DR1. The plating layer 36 is disposed over the plating layer 35.

In the resistor 300, the electrode 40 includes a plating layer 44, a plating layer 45, and a plating layer 46. A constituent material of the plating layer 44, a constituent material of the plating layer 45, and a constituent material of the plating layer 46 are, for example, copper, nickel, and tin, respectively. The plating layer 44 is disposed over the other end portion of surface 12a in the first direction DR1. The plating layer 44 is also disposed over the other end portion of the surface 12b in the first direction DR1. The plating layer 45 is disposed over the plating layer 44. The plating layer 45 is also disposed over a side surface of the resistive body 12 at the other end in the first direction DR1. The plating layer 46 is disposed over the plating layer 45.

In the resistor 300, a recess 30a reaches one end of the resistive body 12 in the first direction DR1, and a recess 40a reaches the other end of the resistive body 12 in the first direction DR1. In the resistor 300, the protective film 20 is disposed over the surface 12a exposed from the electrode 30 and the electrode 40. More specifically, the protective film 20 is disposed over the surface 12a between the electrode 30 and the electrode 40 in the first direction DR1 and over the surface 12a exposed from the recess 30a and the recess 40a.

The resistor 300 further includes a protective film 21. A constituent material of the protective film 21 is the same as, for example, the constituent material of the protective film 20. The protective film 21 is disposed over the surface 12b exposed from the electrode 30 and the electrode 40. In this respect, the configuration of the resistor 300 is the same as the configuration of the resistor 200.

### First Modification

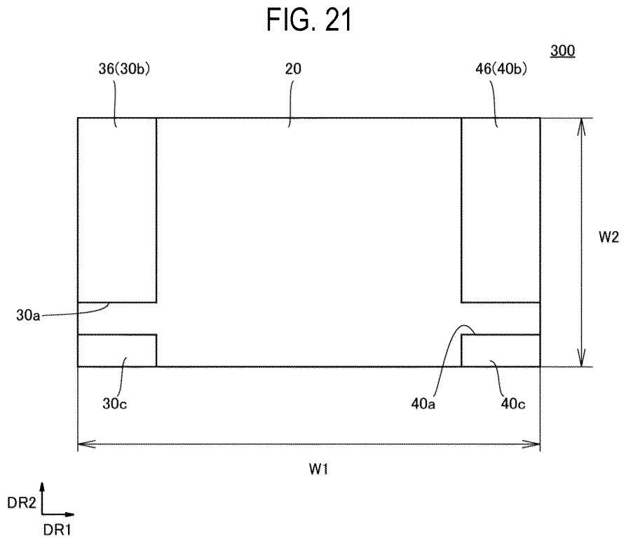

In the above, an example in which a width W2 is wider than a width W1 has been described. FIG. 21 is a bottom view of a resistor 300 according to a first modification. As shown in FIG. 21, in the resistor 300, the width W2 may be narrower than the width W1.

### Second Modification

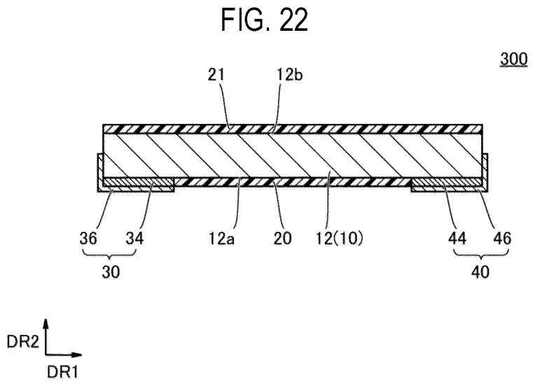

FIG. 22 is a cross-sectional view of a resistor 300 according to a second modification.

As shown in FIG. 22, in the resistor 300, the electrode 30 may not include the plating layer 35, and the electrode 40 may not include the plating layer 45. In this case, the plating layer 34 is also disposed over the side surface of the resistive body 12 at one end in the first direction DR1, and the plating layer 44 is also disposed over the side surface of the resistive body 12 at the other end in the first direction DR1. Further, in this case, the plating layer 36 and the plating layer 46 are disposed over the plating layer 34 and the plating layer 44, respectively. Furthermore, in the resistor 300, the plating layer 34 may not be disposed over the one end portion of the surface 12b in the first direction DR1, and the plating layer 44 may not be disposed over the other end portion of the surface 12b in the first direction DR1. In this case, the protective film 21 is disposed over the entire surface 12b.

### Method of Manufacturing Resistor 300

A method of manufacturing the resistor 300 will be described below.

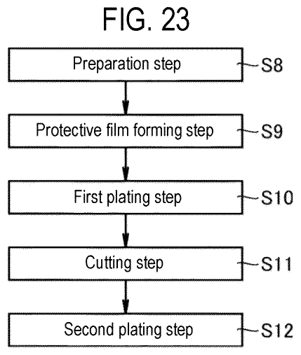

FIG. 23 is a process diagram showing a method of manufacturing the resistor 300. As shown in FIG. 23, the method of manufacturing the resistor 300 includes a preparation step S8, a protective film forming step S9, a first plating step S10, a cutting step S11, and a second plating step S12.

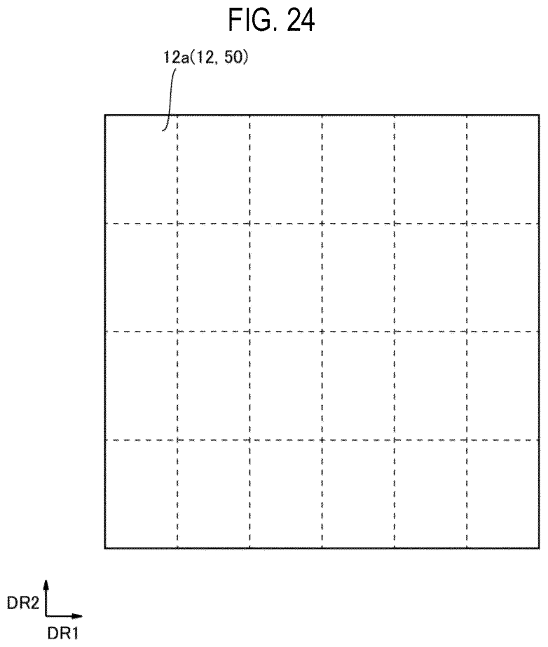

FIG. 24 is a bottom view for explaining the preparation step S8. As shown in FIG. 24, in the preparation step S8, a frame 50 is prepared. The frame 50 includes a plurality of frames 10 (resistive bodies 12). The plurality of resistive bodies 12 included in the frame 50 are divided by dotted lines in FIG. 24. After the preparation step S8, the protective film forming step S9 is performed.

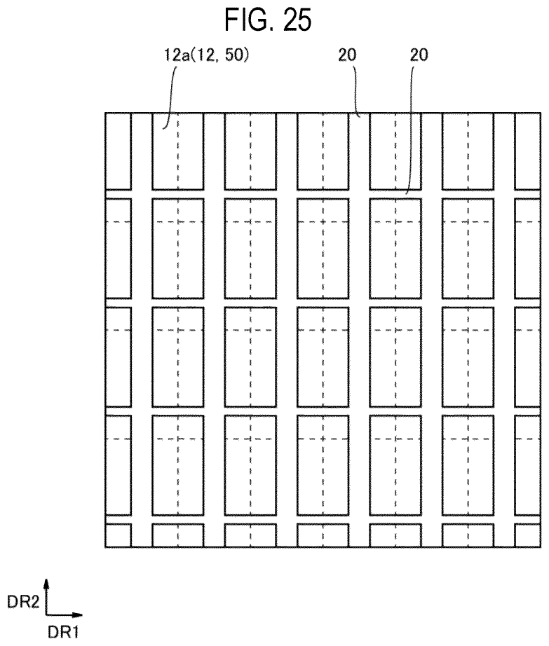

FIG. 25 is a bottom view for explaining the protective film forming step S9. As shown in FIG. 25, in the protective film forming step S9, the protective film 20 is formed. The protective film 20 includes a plurality of first straight line portions and a plurality of second straight line portions. Each of the plurality of first straight line portions extends along the first direction DR1. The plurality of first straight line portions are lined up at intervals in the second direction DR2. Each of the plurality of second straight line portions extends along the second direction DR2. The plurality of second straight line portions are lined up at intervals in the first direction DR1. There is one intersection of the first straight line portion and the second straight line portion on the surface 12a of each of the plurality of resistive bodies 12 included in the frame 50. The protective film 20 is formed by applying the constituent material (uncured resin material) of the protective film 20 and heating and curing the applied uncured resin material. Note that in the protective film forming step S9, although not shown, the protective film 21 is also formed by the same method. After the protective film forming step S9, the first plating step S10 is performed.

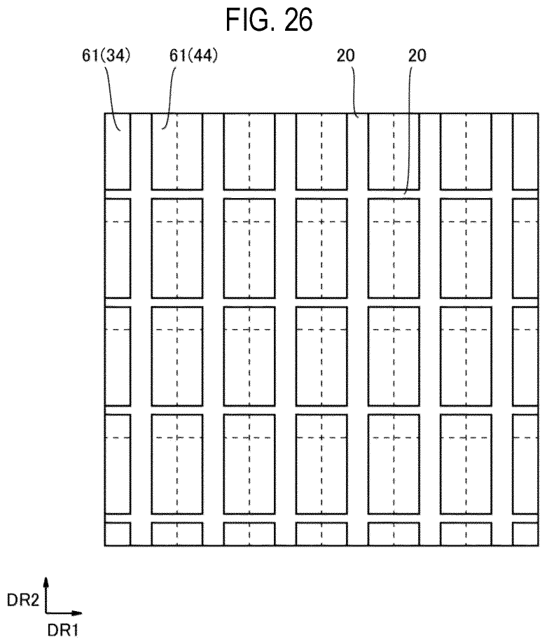

FIG. 26 is a bottom view for explaining the first plating step S10. As shown in FIG. 26, in the first plating step S10, a plating layer 61 is formed on the surface 12a exposed from the protective film 20, for example, by performing rack plating. After the first plating step S10, the cutting step S11 is performed. In the cutting step S11, the frame 50 is cut to be segmented into the plurality of resistive bodies 12. As the frame 50 is cut, the plating layer 61 is separated into the plating layer 34 and the plating layer 44. After the cutting step S11, the second plating step S12 is performed.

In the second plating step S12, for example, by performing barrel plating, the plating layer 35 and the plating layer 36 are sequentially formed, and the plating layer 45 and the plating layer 46 are sequentially formed. The plating layer 35 and the plating layer 36 grow only over the plating layer 34 and not over the protective film 20. Similarly, the plating layer 45 and the plating layer 46 grow only over the plating layer 44 and not over the protective film 20. In this way, the recess 30a and the recess 40a are formed at the electrode 30 and the electrode 40, respectively. Through the above steps, the resistor 300 having the structure shown in FIGS. 18 to 20 is formed.

### Effects of Resistor 300

Effects of the resistor 300 will be described below.

In the resistor 300, by forming the protective film 20 to include the plurality of first straight line portions and the plurality of second straight line portions when the protective film forming step S9 is performed, the recess 30a and the recess 40a are formed at the electrode 30 and the electrode 40, respectively. In this way, the resistor 300 may be made into four terminals without adding any new step and may be used as, for example, a shunt resistor.

### Supplementary Notes

The above embodiments include the following configurations.

### Supplementary Note 1

A resistor including:
a frame including a resistive body and a resin layer;
a protective film; and
a first electrode and a second electrode,
wherein the resistive body includes a surface and is buried in the resin layer such that the surface is exposed,
wherein the protective film is disposed over a central portion of the surface in a first direction,
wherein the first electrode is disposed over one end portion of the surface in the first direction and extends to reach over the protective film,
wherein the second electrode is disposed over the other end portion of the surface in the first direction and extends to reach over the protective film, and
wherein a width of the resistor in a second direction perpendicular to the first direction is wider than a width of the resistor in the first direction.

### Supplementary Note 2

The resistor of Supplementary Note 1, wherein the width of the resistor in the second direction is 3.2 mm or less.

### Supplementary Note 3

A resistor including:
a frame including a resistive body;
a first electrode and a second electrode; and
a protective film,
wherein the resistive body includes a surface,
wherein the first electrode is disposed over one end portion of the surface in a first direction,
wherein the second electrode is disposed over the other end portion of the surface in the first direction,
wherein a first recess and a second recess are respectively formed at an end of the first electrode, which is an end near the second electrode, and at an end of the second electrode, which is an end near the first electrode, and
wherein the protective film is disposed over the surface exposed from at least the first electrode and the second electrode.

### Supplementary Note 4

The resistor of Supplementary Note 3, wherein a width of the resistor in a second direction perpendicular to the first direction is wider than a width of the resistor in the first direction.

### Supplementary Note 5

The resistor of Supplementary Note 3, wherein a width of the resistor in the first direction is wider than a width of the resistor in a second direction perpendicular to the first direction.

### Supplementary Note 6

The resistor of any one of Supplementary Notes 3 to 5, wherein the frame further includes a resin layer,
wherein the resistive body is buried in the resin layer such that the surface is exposed,
wherein the protective film is disposed over a central portion of the surface in the first direction, and
wherein each of the first electrode and the second electrode extends to reach over the protective film.

### Supplementary Note 7

The resistor of any one of Supplementary Notes 3 to 5, wherein the frame includes only the resistor,
wherein the first recess reaches one end of the resistive body in the first direction, and
wherein the second recess reaches the other end of the resistive body in the first direction.

Although the embodiments of the present disclosure have been described as above, the above-described embodiments may be modified in various ways. Further, the scope of the present disclosure is not limited to the above-described embodiments. The scope of the present disclosure is indicated by the claims and is intended to include all changes within the meaning and scope equivalent to the claims.

According to the present disclosure in some embodiments, it is possible to improve heat dissipation to a substrate.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A resistor comprising:
a frame including a resistive body and a resin layer;
a protective film; and
a first electrode and a second electrode,
wherein the resistive body includes a surface and is buried in the resin layer such that the surface is exposed,
wherein the protective film is disposed over a central portion of the surface in a first direction,
wherein the first electrode is disposed over one end portion of the surface in the first direction and extends to reach over the protective film,
wherein the second electrode is disposed over the other end portion of the surface in the first direction and extends to reach over the protective film, and
wherein a width of the resistor in a second direction perpendicular to the first direction is wider than a width of the resistor in the first direction.

2. The resistor of claim 1, wherein the width of the resistor in the second direction is 3.2 mm or less.

3. A resistor comprising:
a frame including a resistive body;
a first electrode and a second electrode; and
a protective film,
wherein the resistive body includes a surface,
wherein the first electrode is disposed over one end portion of the surface in a first direction,
wherein the second electrode is disposed over the other end portion of the surface in the first direction,
wherein a first recess and a second recess are respectively formed at an end of the first electrode, which is an end near the second electrode, and at an end of the second electrode, which is an end near the first electrode, and
wherein the protective film is disposed over the surface exposed from at least the first electrode and the second electrode.

4. The resistor of claim 3, wherein a width of the resistor in a second direction perpendicular to the first direction is wider than a width of the resistor in the first direction.

5. The resistor of claim 3, wherein a width of the resistor in the first direction is wider than a width of the resistor in a second direction perpendicular to the first direction.

6. The resistor of claim 3, wherein the frame further includes a resin layer,
wherein the resistive body is buried in the resin layer such that the surface is exposed,
wherein the protective film is disposed over a central portion of the surface in the first direction, and
wherein each of the first electrode and the second electrode extends to reach over the protective film.

7. The resistor of claim 3, wherein the frame includes only the resistor,
wherein the first recess reaches one end of the resistive body in the first direction, and
wherein the second recess reaches the other end of the resistive body in the first direction.
